(19) United States
(12) Patent Application Publication
(10) Pub. No.: US 2014/0017608 A1
(43) Pub. Date: Jan. 16, 2014

(54) TONER AND PROCESS FOR PRODUCING SAME

(71) Applicant: Satoru Ariyoshi, Osaka-shi (JP)

(72) Inventor: Satoru Ariyoshi, Osaka-shi (JP)

(73) Assignee: SHARP KABUSHIKI KAISHA, Osaka-shi, Osaka (JP)

(21) Appl. No.: 14/008,924

(22) PCT Filed: Mar. 14, 2012
(86) PCT No.: PCT/JP2012/056571

§ 371 Date: Sep. 30, 2013

(30) Foreign Application Priority Data
Mar. 29, 2011 (JP) 2011-072811

(51) Int. Cl. G03G 9/087

(52) U.S. Cl. CPC G03G 9/08755
USPC 430/109.4; 430/137.2

(57) ABSTRACT

A toner comprising at least a binder resin, a colorant and a release agent, wherein the binder resin contains: a polyester resin A obtained by polycondensation of an aromatic dicarboxylic acid, a rosin and an alcohol having three or more hydroxyl groups, a content of the rosin being 60% by weight or more; and a polyester resin B obtained by polycondensation of an aromatic dicarboxylic acid, a rosin and a polyhydric alcohol, a content of the rosin being 5 to 60% by weight, wherein 50 to 200 parts by weight of the polyester resin B is contained with respect to 100 parts by weight of the polyester resin A.

### TECHNICAL FIELD

The present invention relates to a toner and a process for producing the same.

### BACKGROUND ART

Toner for developing latent images is used for various kinds of image formation processes. For example, it is used for an electrophotographic image formation process.

Generally, image forming apparatuses using an electrophotographic image formation process form a desired image on a recording medium by carrying out: a charge step of uniformly charging a photosensitive layer on a surface of a photoconductor drum serving as a latent image carrier; an exposure step of projecting signal light of an image on a document onto the surface of the photoconductor drum in a charged state to form an electrostatic latent image; a development step of developing the electrostatic latent image on the surface of the photoconductor drum by supplying an electrophotographic toner to the electrostatic latent image; a transfer step of transferring the toner image on the surface of the photoconductor drum onto a recording medium such as paper and OHP sheets; a fixing step of fixing the toner image on the recording medium by heating and pressurization; and a cleaning step of cleaning the surface of the photoconductor drum by removing toner and the like left on the surface of the photoconductor drum after the transfer of the toner image with a cleaning blade. The transfer of the toner image to the recording medium may be performed via an intermediate transfer medium.

An electrophotographic toner used for such image formation is produced by, for example, a kneading and pulverizing method or a polymerization method represented by a suspension polymerization method and an emulsion polymerization aggregation method. In the kneading and pulverizing method, toner materials containing a binder resin and a colorant as main components, and optionally containing a release agent, a charge controlling agent, and the like added and mixed therein are melted and kneaded, cooled and solidified, and then pulverized and classified to produce a toner.

In recent years, various efforts have been made in various technical areas from a viewpoint of global environment conservation. Currently, materials of many manufactures are produced from petroleum. However, producing and burning these materials need energy and emit carbon dioxide. Efforts to reduce such energy and carbon dioxide emission are very important as measures against global warming.

As a new effort to reduce carbon dioxide emission as one of the measures against global warming, utilization of resources derived from organisms, which are referred to as biomass, has been attracting much attention. Biomass is a concept expressing the amount (mass) of biological resources (bio) and is defined as “renewable organic resources derived from organisms excluding fossil resources”. That is, biomass means organic substances produced by organisms from solar energy, water and carbon dioxide through photosynthesis. Since the carbon dioxide to be emitted when biomass is burnt originates from atmospheric carbon dioxide absorbed by organisms through photosynthesis, the overall amount of carbon dioxide in the atmosphere is considered balanced.

Being uninfluential on increase and decrease in the atmospheric carbon dioxide as described above is referred to as carbon-neutral. It is considered that the utilization of carbon-neutral biomass does not increase the amount of carbon dioxide in the atmosphere.

Biomass materials which are produced from such biomass are referred to as biomass polymers, biomass plastics, nonpetroleum-based polymeric materials, and the like. Such biomass materials are made from monomers called biomass monomers.

In the field of electrophotography, efforts of utilizing biomass have been made, which is resources being environmentally-safe and effective in controlling carbon dioxide increase.

For example, Patent Document 1 discloses a resin composition for an electrophotographic toner capable of providing a toner combining all low-temperature fixability, hot offset resistance and development durability, the composition containing a polyester resin having a softening point of 80 to 120° C. obtained by including a rosin as an essential component and a polyester resin having a softening point of 160° C. or higher obtained by including a polyvalent epoxy compound as an essential component.

### RELATED ART DOCUMENT

### Patent Document

Patent Document 1: Japanese Unexamined Patent Publication No. 2008-122509

### SUMMARY OF THE INVENTION

### Problems to be Solved by the Invention

However, the toner produced by the method disclosed in Patent Document 1 has a problem in that the toner will be less resistant and reduced in durability if the rosin content in the resin composition for the toner is increased in order to increase the biomass utilization rate. When such a toner is used as a developer, the toner may be crushed by stress such as stirring in a developer tank of a copying machine, and fine particles may be generated to result in an unstable charge amount and reduced toner elasticity, easily leading to occurrence of hot offset. Furthermore, when such a toner is used for a color toner, the optical transparency may be impaired.

It is therefore an object of the present invention to provide a toner containing a high amount of rosin as biomass and having excellent hot offset resistance, charging stability and optical transparency.

### Means for Solving the Problems

The inventor of the present invention has made intensive efforts and studies, and as a result, found that a toner comprising: a polyester resin A obtained by polycondensation of an aromatic dicarboxylic acid, a biomass-derived rosin and an alcohol having three or more hydroxyl groups; and a polyester resin B obtained by polycondensation of an aromatic dicarboxylic acid, a rosin and a polyhydric alcohol has excellent hot offset resistance, charging stability and optical transparency, to reach completion of the present invention.

The present invention therefore provides a toner comprising at least a binder resin, a colorant and a release agent, wherein the binder resin contains: a polyester resin A obtained by polycondensation of an aromatic dicarboxylic acid, a rosin and an alcohol having three or more hydroxyl groups, a content of the rosin being 60% by weight or more; and a polyester resin B obtained by polycondensation of an aromatic dicarboxylic acid, a rosin and a polyhydric alcohol, a content of the rosin being 5 to 60% by weight, wherein 50 to 200 parts by weight of the polyester resin B is contained with respect to 100 parts by weight of the polyester resin A.

The present invention also provides the toner, wherein the rosins are disproportionated rosins, and the polyester resin A has a softening temperature of 120° C. or lower and a weight average molecular weight of 1.00×10³ to 9.00×10³ and is soluble in tetrahydrofuran (THF).

The present invention also provides the toner, wherein the polyester resin B has a storage modulus of 10³ to 10⁵ Pa·s at the softening temperature of the polyester resin A and a softening temperature of 160° C. or lower.

The present invention also provides a process for producing a toner comprising at least a binder resin, a colorant and a release agent, the process comprising: a mixing step of mixing a binder resin with a colorant to prepare a mixture; a melting and kneading step of melting and kneading the mixture to prepare a kneaded product; a cooling and pulverizing step of cooling, solidifying and pulverizing the kneaded product to prepare a pulverized product; and a classifying step of classifying the pulverized product, wherein the binder resin contains: a polyester resin A obtained by polycondensation of an aromatic dicarboxylic acid, a rosin and an alcohol having three or more hydroxyl groups, a content of the rosin being 60% by weight or more; and a polyester resin B obtained by polycondensation of an aromatic dicarboxylic acid, a rosin and a polyhydric alcohol, a content of the rosin being 5 to 60% by weight, wherein 50 to 200 parts by weight of the polyester resin B is contained with respect to 100 parts by weight of the polyester resin A.

The present invention also provides the process for producing the toner, wherein the mixing step comprises mixing and kneading the polyester resin A with the colorant to prepare a masterbatch, and mixing the polyester resin B with the masterbatch to prepare a mixture.

### Effects of the Invention

A toner according to the present invention includes the polyester resin A and the polyester resin B as a binder resin, and can maintain a viscoelasticity needed for the hot offset resistance, because the polyester resin B has a storage modulus of 10³ to 10⁵ Pa·s at the softening temperature of the polyester resin A.

In addition, since both the polyester resins A and B have a resin skeleton containing a rosin, the miscibility between the resins is good enough to improve the dispersibility of the constituent materials as a whole. Accordingly, the dispersibility of the release agent, which is a component needed for the improvement of the hot offset resistance, is also improved. Thus, it is possible to obtain a toner having good hot offset resistance.

Furthermore, the good miscibility between the resins improves the homogeneity of the polyester resin A and the polyester resin B, and therefore it is possible to obtain a toner having good optical transparency as a color toner.

In addition, the process for producing the toner according to the present invention comprises a mixing step, a melting and kneading step, a cooling and pulverizing step, and a classifying step.

In the mixing step, a mixture is prepared by mixing, as a binder resin, the polyester resin A obtained by polycondensation of an aromatic dicarboxylic acid, a rosin and an alcohol having three or more hydroxyl groups as raw materials, a content of the rosin in the raw materials being 60% by weight or more, and the polyester resin B obtained by polycondensation of an aromatic dicarboxylic acid, a rosin and a polyhydric alcohol as raw materials; a colorant; and a release agent.

In the melting and kneading step, a kneaded product is prepared by melting and kneading the mixture.

In the cooling and pulverizing step, a pulverized product is prepared by cooling, solidifying and pulverizing the kneaded product.

In the classifying step, the pulverized product obtained in the cooling and pulverizing step is classified.

### BRIEF DESCRIPTION OF THE DRAWINGS

FIG. 1 is a flow chart illustrating an example of steps of a process for producing the toner of the present invention.

### MODE FOR CARRYING OUT THE INVENTION

The rosin to be used in the present invention includes: tall rosin obtained by steam distillation of by-product crude tall oil produced in a manufacturing process including pulping of pine wood by the Kraft process; gum rosin obtained by steam distillation of crude colophony collected through hacking the bark away from a pine tree; and wood rosin obtained by distillation of an extract obtained by extraction of chips of a stump of a felled pine tree with an organic solvent. These rosins can be obtained by conventionally-known production methods.

Approximately 90% of rosin consists of resin acids. Rosin contains as a main component a mixture of resin acids such as abietic acid, palustric acid, neoabietic acid, pimaric acid, dehydroabietic acid, isopimaric acid and sandaracopimaric acid.

The disproportionation of rosin is usually carried out with a palladium on activated carbon catalyst (U.S. Pat. No. 2,177,530), a sulfur-based catalyst (Japanese Examined Patent Publication No. SHO 49 (1974)-5360) or an iodine-based catalyst (Japanese Unexamined Patent Publication No. SHO 51 (1976)-34896).

In the disproportionation, two molecules of rosin are reacted, of which one molecule becomes an aromatic compound as its double bond increases to three, and the other molecule becomes a compound having a single double bond as one double bond of its conjugated double bonds is hydrogenated. The disproportionated rosin is characterized in that it is more resistant to alteration compared to rosin having unstable conjugated double bonds.

Accordingly, from a viewpoint of stability, the disproportionated rosin is preferable as the rosin to be used for the polyester resin A in the present invention.

The disproportionated rosin is composed mainly of a mixture of dehydroabietic acid and dihydroabietic acid. The disproportionated rosin includes a bulky and rigid skeleton of a hydrophenanthrene ring. Therefore, in the case where the disproportionated rosin is introduced as a component of the polyester, it is possible to accelerate rise of the apparent glass transition temperature to obtain a toner having better storage stability, compared to the case where non-disproportionated rosin is used.

Accordingly, the term “rosin” used in the present invention includes not only the above-mentioned tall rosin, gum rosin and wood rosin but also disproportionated rosin obtained by disproportionation of these rosins.

### 1. Process for Producing Toner

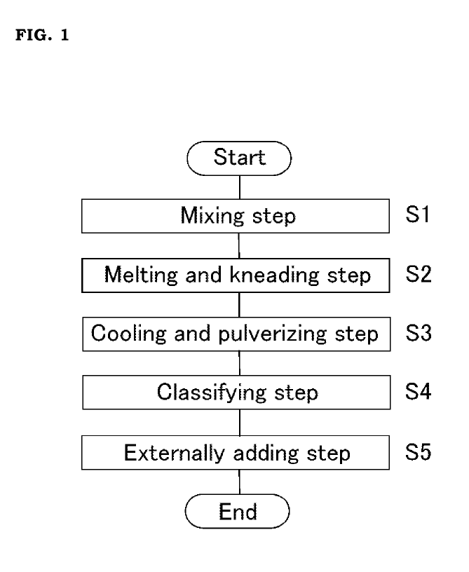

FIG. 1 is a flow chart illustrating an example of steps of a process for producing the toner of the present invention. The toner of the present invention is mainly composed of a binder resin and a colorant, and is produced by a process for producing the toner according to the present invention. The process for producing the toner according to the present invention is a particle formation method by dry process, and includes, but is not limited to, a mixing step S1, a melting and kneading step S2, a cooling and pulverizing step S3, a classifying step S4, and an externally adding step S5.

### (1) Mixing Step S1

In the mixing step S1, a binder resin, a colorant and a release agent are dry-blended with a blender to give a mixture. In the blending, an additive may be added as needed.

Examples of the additive include magnetic powder and a charge controlling agent.

### (Binder Resin)

The toner of the present invention contains the polyester resin A and the polyester resin B as a binder resin. The polyester resin is suitable as a material of color toner as having excellent transparency and being capable of imparting good powder flowability, low-temperature fixability and secondary color reproduction characteristics to toner particles. The polyester resin A and the polyester resin B are obtained by polycondensation of an acid component such as polybasic acid and a polyhydric alcohol as starting materials.

The polyester resin A and the polyester resin B are prepared by a commonly-known polycondensation reaction method. As the reaction method, transesterification or direct esterification may be applied. In addition, the polycondensation can be accelerated by increasing the reaction temperature by pressurization or applying an inert gas under reduced pressure or normal pressure.

The reaction may be accelerated by using a commonly-known and conventionally-used catalyst such as a compound of at least one metal selected from antimony, titanium, tin, zinc, aluminum and manganese. Preferably, the amount of the catalyst to add is 0.01 to 1.0 parts by weight with respect to 100 parts by weight in total of the acid component and the polyhydric alcohol.

In the preparation of the polyester resin A, an aromatic dicarboxylic acid and a rosin are used as the acid component, and an alcohol having three or more hydroxyl groups is used as the polyhydric alcohol as a starting material. The aromatic dicarboxylic acid and the alcohol having three or more hydroxyl groups are reacted to form a polyol structure having a modest degree of branching.

When the polyester resin includes the structure of the modest degree of branching, the low-temperature fixability of the toner can be maintained without extremely increasing the softening temperature of the resin, and the molecular weight distribution of the resin can be enlarged. Thus, a resin having a large distribution on the high molecular weight side can be obtained, and therefore the offset resistance of the toner is enhanced.

Examples of the aromatic dicarboxylic acid as the acid component to be used in the preparation of the polyester resin A include phthalic acid, terephthalic acid, isophthalic acid, biphenyldicarboxylic acid, naphthalenedicarboxylic acid and 5-tert-butyl-1,3-benzene dicarboxylic acid.

Alternatively, as the acid component of the polyester resin A, an aromatic dicarboxylic acid derivative such as an aromatic dicarboxylic acid anhydride or lower alkyl ester may be used instead of the aromatic dicarboxylic acid.

Among the aromatic dicarboxylic acid compounds, at least one of terephthalic acid, isophthalic acid and a lower alkyl ester thereof is preferably used.

Examples of the lower alkyl group composing the aromatic dicarboxylic acid lower alkyl ester include C₁-C₄ alkyl group, that is, methyl, ethyl, n-propyl, isopropyl, n-butyl and isobutyl groups.

Terephthalic acid and isophthalic acid have a great electron resonance stabilization effect owing to their aromatic ring skeleton and show excellent charging stability, thereby providing a resin having appropriate strength. Examples of the lower alkyl ester of terephthalic acid and isophthalic acid include dimethyl terephthalate, dimethyl isophthalate, diethyl terephthalate, diethyl isophthalate, dibutyl terephthalate and dibutyl isophthalate.

Among them, dimethyl terephthalate or dimethyl isophthalate is preferably used from a viewpoint of costs and handling.

These aromatic dicarboxylic acid compounds may be used independently, or two or more kinds may be used in combination.

Preferably, the mole ratio of the alcohol having three or more hydroxyl groups to the aromatic dicarboxylic acid compound in the polyester resin A is 1.05 to 1.65. It is not preferable that the mole ratio of the alcohol having three or more hydroxyl groups to the aromatic dicarboxylic acid compound is less than 1.05, because in this case, the molecular weight distribution of the resin on the high molecular weight side is enlarged and the Tm is increased to decrease the low-temperature fixability of the toner. In addition, in this case, it is impossible to control the enlargement of the molecular weight distribution to result in gelation of the toner. It is not preferable that the mole ratio is more than 1.65, because in this case, the polyester resin includes less branching, and therefore the softening temperature and the glass transition temperature thereof are lowered. As a result, the storage stability of the toner is decreased.

As described above, the polyester resin A is obtained by polycondensation of an aromatic dicarboxylic acid, a rosin and an alcohol having three or more hydroxyl groups as starting materials. In the present invention, in order to obtain a toner having excellent environmental safety, the rosin content in the total content of the starting materials is 60% by weight or more for an underlying structure of the polyester resin A.

Preferably, the rosin content is 15 to 45 parts by weight with respect to 100 parts by weight of the toner. It is not preferable that the rosin content is less than 15 parts by weight, because in this case, the global environment conservation effect by the use of biomass is reduced. It is not preferable that the rosin content is more than 45 parts by weight, because in this case, the mechanical strength and the powder flowability of the toner are likely to be reduced.

For the polyester resin A, aliphatic polycarboxylic acid or tribasic or higher aromatic polycarboxylic acid having carboxy groups may be further used as an acid component other than the aromatic dicarboxylic acid compounds and rosin.

Examples of the aliphatic polycarboxylic acid include alkyl dicarboxylic acids such as succinic acid, adipic acid, sebacic acid, and azelaic acid; unsaturated dicarboxylic acids such as succinic acid, fumaric acid, maleic acid, citraconic acid, itaconic acid, and glutaconic acid substituted with an alkyl group having 16 to 18 carbon atoms; and dimmer acid.

The aliphatic polycarboxylic acids may be used independently, or two or more kinds may be used in combination. In addition, monobasic acids such as benzonic acid and p-tert-butyl benzonic acid may be used as needed.

The aliphatic polycarboxylic acid content in the polyester resin A is preferably 0.5 to 15 moles, and more preferably 1 to 13 moles with respect to 100 moles of the aromatic dicarboxylic acid compound. When the aliphatic polycarboxylic acid content in the polyester resin A is within the above-mentioned range, the low-temperature fixability of the toner is improved.

Examples of the tribasic or higher aromatic polycarboxylic acid having carboxy groups include trimellitic acid, pyromellitic acid, naphthalenetricarboxylic acid, benzophenonetetracarboxylic acid, biphenyltetracarboxylic acid, and anhydrides thereof. These aromatic polycarboxylic acids may be used independently, or two or more kinds may be used in combination. Among these aromatic polycarboxylic acids, trimellitic anhydride is preferably used from a viewpoint of reactivity.

The content of the tribasic or higher aromatic polycarboxylic acid having carboxy groups in the polyester resin A is preferably 0.1 to 5 moles, and more preferably 0.5 to 3 moles with respect to 100 moles of the aromatic dicarboxylic acid compound. When the content of the tribasic or higher aromatic polycarboxylic acid having carboxy groups in the polyester resin A is less than 0.1 moles, the branching of the polyester resin A is insufficient, and the polyester resin A having a large distribution on the high molecular weight side cannot be obtained, and therefore the offset resistance of the toner may be reduced. On the other hand, when the content is more than 5 moles, the softening temperature of the polyester resin A is raised, and therefore the low-temperature fixability of the toner may be reduced.

Examples of the polyhydric alcohol to be used for the polyester resin A include trimethylolethane, trimethylolpropane, glycerin and pentaerythritol. At least one of the polyhydric alcohols may be used. Among them, glycerin is more preferable, because it is easily obtainable as a manufacturing technique thereof from a plant-derived material has been industrially established, and an effect of promoting the use of biomass is obtained.

In addition, for the polyester resin A, at least one of aliphatic diol and etherified diphenol may be further used as a polyhydric alcohol other than the alcohol having three or more hydroxyl groups.

Examples of the aliphatic diol include ethylene glycol, 1,2-propanediol, 1,3-propanediol, 1,2-butanediol, 1,3-butanediol, 1,4-butanediol, 2,3-butanediol, 1,4-butenediol, 2-methyl-1,3-propanediol, 1,5-pentanediol, neopentyl glycol, 2-ethyl-2-methylpropane-1,3-diol, 2-butyl-2-ethylpropane-1,3-diol, 1,6-hexanediol, 3-methyl-1,5-pentanediol, 2-ethyl-1,3-hexanediol, 2,4-dimethyl-1,5-pentanediol, 2,2,4-trimethyl-1,3-pentanediol, 1,7-heptanediol, 1,8-octanediol, 1,9-nonanediol, 1,10-decanediol, 3-hydroxy-2,2-dimethylpropyl-3-hydroxy-2,2-dimethylpropanoate, diethylene glycol, triethylene glycol and dipropylene glycol.

Among these aliphatic diols, ethylene glycol, 1,3-propanediol or neopentyl glycol is preferably used from a viewpoint of the reactivity with acid and of the glass transition temperature of the resin. These aliphatic diols may be used independently, or two or more kinds may be used in combination.

Preferably, the aliphatic diol content in the polyester resin A is 5 to 20 moles with respect to 100 moles of the aromatic dicarboxylic acid compound.

The etherified diphenol is a diol obtained by addition reaction of bisphenol A and alkylene oxide. Examples of the alkylene oxide include ethylene oxide and propylene oxide, and the alkylene oxide is preferably added so that the average addition mole number is 2 to 16 moles with respect to 1 mole of bisphenol A.

Preferably, the etherified diphenol content in the polyester resin A is 5 to 35 moles with respect to 100 moles of the aromatic dicarboxylic acid compound.

Preferably, the polyester resin A content in the toner is 20 to 60 parts by weight with respect to 100 parts by weight of the toner.

When the polyester resin A content in the toner is less than 20 parts by weight, the viscosity of the toner is increased, and the low-temperature fixability of the toner is impaired. On the other hand, when the polyester resin A content in the toner is more than 60 parts by weight, the rosin content is increased, and therefore the mechanical strength and the powder flowability of the toner is reduced.

The polyester resin B imparts high-temperature offset resistance to the toner, and therefore preferably has high-molecular weight and high viscosity.

As the acid component of the polyester resin B, the same aromatic dicarboxylic acid compound as in the polyester resin A can be used. The aromatic dicarboxylic acid compound contained in the polyester resin A and the aromatic dicarboxylic acid compound contained in the polyester resin B may be the same or different. In addition, for the polyester resin B, the same aliphatic polycarboxylic acid, or tribasic or higher aromatic polycarboxylic acid having carboxy groups as in the polyester resin A may be further used as a starting acid component other than the aromatic dicarboxylic acid compound. The acid components may be the same or different between the polyester resins A and B.

For the polyhydric alcohol of the polyester resin B, the same alcohols having three or more hydroxyl groups, aliphatic diols and etherified diphenols as in the polyester resin A can be used. The polyhydric alcohols may be the same or different between the polyester resins A and B. In addition, cycloaliphatic diols such as cyclohexanedimethanol may be also used. The polyhydric alcohols may be used independently, or two or more kinds may be used in combination. Furthermore, monoalcohols such as stearyl alcohol may be used as needed to the extent that the effect of the present invention is not lessened.

The same rosin as in the polyester resin A can be used in the polyester resin B. Preferably, the rosin is a disproportionated rosin.

The rosin content in the polyester resin B is not particularly limited, but is preferably 5 to 60 parts by weight with respect to 100 parts by weight of the polyester resin B, because the present invention improves the miscibility between the polyester resins A and B, and furthermore improves the dispersibility of the toner constituent materials by including a rosin in both the resins and employing similar resin skeletons for the resins. When the rosin content is less than 5 parts by weight, the effect of improving the miscibility between the resins is lessened. When the rosin content is more than 60 parts by weight, the mechanical strength and the elasticity of the toner are reduced, and the viscoelasticity needed for the hot offset resistance cannot be maintained.

Preferably, the polyester resin B has a storage modulus of 10³ to 10⁵ Pa·s at the softening temperature of the polyester resin A. When the storage modulus of the polyester resin B at the softening temperature of the polyester resin A is less than 10³ Pa·s, the hot offset resistance of the toner is not obtained. On the other hand, when the storage modulus of the polyester resin B at the softening temperature of the polyester resin A is more than 10⁵ Pa·s, the difference in the melt viscosity between the polyester resin A and the polyester resin B in kneading is so large that the miscibility between the resins is reduced, and the polyester resin A and the polyester resin B disperse in the toner nonuniformly. A portion of a toner particle where the ratio of the polyester resin A is higher is easily broken, and the breakage causes generation of fine powder having a small particle diameter. The fine powder enlarges the particle size distribution and the charge distribution, and as a result, a defect such as image fogging is caused.

The glass transition temperature of the polyester resin A and the polyester resin B is not particularly limited and can be selected as appropriate from a wide range. The glass transition temperature is preferably 160° C. or lower, and more preferably 45 to 80° C. and still more preferably 50 to 65° C. considering the storage stability and the low-temperature fixability of the toner to be obtained. When the glass transition temperature of the polyester resin A and the polyester resin B is below 45° C., the storage stability of the toner is insufficient, and therefore the toner easily heat-aggregates inside the image forming apparatus, and defective development is caused. Furthermore, the temperature at which hot offset starts to occur (hereinafter, referred to as “hot offset start temperature”) is lowered.

The “hot offset” is a phenomenon whereby a part of toner is taken away, adhering to a fixing member when the cohesive force between toner particles is smaller than the adhesive force between the toner and the fixing member during heating and pressurizing of the toner by the fixing member for fixation onto a recording medium, and therefore the toner layer is broken into some parts. When the glass transition temperature of the polyester resins A and B is higher than 80° C., the low-temperature fixability of the toner is reduced, and defective fixation is caused.

As the binder resin, resins conventionally used as binder resins for toner such as polystyrenic polymer; polystyrenic copolymer including styrene-acrylic resins; and polyester resins other than the above-described polyester resins may be used as well as the above-described polyester resins to the extent that the effect of the present invention can be achieved.

### (Colorant)

As the colorant to be included in the toner of the present invention, organic dyes, organic pigments, inorganic dyes and inorganic pigments which are regularly used in the field of electrophotography can be used. Out of the dyes and the pigments, the pigments are preferably used. Since the pigments are superior to the dyes in light resistance and color forming properties, use of the pigments provides a toner having excellent light resistance and color forming properties.

Examples of yellow colorants include organic pigments such as C.I. Pigment Yellow 1, C.I. Pigment Yellow 5, C.I. Pigment Yellow 12, C.I. Pigment Yellow 15, C.I. Pigment Yellow 17, C.I. Pigment Yellow 74, C.I. Pigment Yellow 93, C.I. Pigment Yellow 180 and C.I. Pigment Yellow 185; inorganic pigments such as yellow oxide and ocher; nitro dyes such as C. I. Acid Yellow 1; and oil-soluble dyes such as C.I. Solvent Yellow 2, C.I. Solvent Yellow 6, C.I. Solvent Yellow 14, C.I. Solvent Yellow 15, C.I. Solvent Yellow 19 and C.I. Solvent Yellow 21, which are categorized according to the Color Index.

Examples of red colorants include C.I. Pigment Red 49, C.I. Pigment Red 57, C.I. Pigment Red 81, C.I. Pigment Red 122, C.I. Solvent Red 19, C.I. Solvent Red 49, C.I. Solvent Red 52, C.I. Basic Red 10 and C.I. Disperse Red 15, which are categorized according to the Color Index.

Examples of blue colorants include C.I. Pigment Blue 15, C.I. Pigment Blue 16, C.I. Solvent Blue 55, C.I. Solvent Blue 70, C.I. Direct Blue 25 and C.I. Direct Blue 86, which are categorized according to the Color Index, and KET Blue 111.

Examples of black colorants include carbon blacks such as channel black, roller black, disk black, gas furnace black, oil furnace black, thermal black and acetylene black.

Other than the above-mentioned colorants, vermilion pigments, green pigments and so on can be used. The colorants may be used independently, or two or more kinds may be used in combination. In addition, colorants in the same color system may be used in combination of two or more kinds thereof. Alternatively, colorants in different color systems may be used in combination of one or more kinds from one color system and one or more kinds from another color system.

Preferably, the colorant is used in the form of a masterbatch in order to be dispersed in the polyester resin uniformly. The masterbatch can be produced by dry blending the polyester resin A and the colorant by using a blender and kneading the resulting powder mixture by using a kneading machine, for example. The kneading temperature depends on the softening temperature of the polyester resin A, and is usually around 50 to 150° C., and preferably around 50 to 120° C.

For the blender for dry blending the masterbatch materials, a commonly known blender may be used. Examples thereof include mixing equipment of a Henschel type such as Henschel mixer (trade name, available from Mitsui Mining Co., Ltd.), Super Mixer (trade name, available from KAWATA MFG Co., Ltd.), Mechanomill (trade name, available from OKADA SEIKO CO., LTD.); Angmill (trade name, available from Hosokawa Micron Corporation); Hybridization System (trade name, available from Nara Machinery Co., Ltd.); Cosmosystem (trade name, available from Kawasaki Heavy Industries, Ltd.); and the like. For the kneading machine, a commonly known kneading machine may be used. For example, general kneading machines such as kneaders, twin screw extruder, double roll mills, triple roll mills and llaboblast mills may be used. Furthermore, specific examples thereof include single-screw extruders and twin-screw extruders such as TEM-100B (trade name, available from Toshiba Machine Co., Ltd.), and PCM-65/87 and PCM-30 (trade names, available from Ikegai Corporation); and open roll kneading machines such as Kneadex (trade name, available from Mitsui Mining Co., Ltd.) The melting and kneading may be performed by using a plurality of kneading machines.

The masterbatch obtained is pulverized so as to have a particle diameter of approximately 2 to 3 mm, for example.

In the case of a black colorant such as a carbon black, the concentration of the colorant in the toner is preferably 5 to 12% by weight, and more preferably 6 to 8% by weight. The concentration of the colorant other than the black colorant is preferably 3 to 8% by weight, and more preferably 4 to 6% by weight. When a masterbatch is used, it is preferable to adjust the amount of the masterbatch to use so that the colorant content in the toner is within the above-mentioned range. When the concentration of the colorant is in the above-mentioned range, the filler effect due to addition of the colorant can be controlled and a toner having high coloring power can be obtained. In this case, in addition, a satisfactory image having a sufficient image density, high color forming properties and excellent image quality can be formed.

### (Release Agent)

For the release agent to be included in the toner of the present invention, those used regularly in this field can be used, and examples thereof include waxes. Examples of the waxes include natural waxes such as paraffin waxes, carnauba waxes and rice waxes; synthetic waxes such as polypropylene waxes, polyethylene waxes and Fischer-Tropsch waxes; coal-based waxes such as montan waxes; petroleum-based waxes; alcohol-based waxes; and ester-based waxes.

The release agent to be included in the toner of the present invention may be used independently, or two or more kinds may be used in combination. The addition amount of the release agent is not particularly limited, and can be selected as appropriate from a wide range according to various conditions such as the kinds and the contents of the other components including the binder resin and the colorant, and properties that the toner to be produced is required to have. Preferably, the addition amount of the release agent is 3 to 10 parts by weight with respect to 100 parts by weight of the binder resin. When the addition amount of the release agent is less than 3 parts by weight, the low-temperature fixability and the hot offset resistance are not improved sufficiently. When the addition amount of the release agent is more than 10 parts by weight, the dispersibility of the release agent in the kneaded product is reduced, and it is impossible to steadily obtain a toner having constant performance. In addition, a phenomenon referred to as filming whereby the toner in the form of a film fuses onto a surface of an image carrier such as a photoconductor occurs.

Preferably, the melting point (Tm) of the release agent is 50 to 180° C. When the melting point is below 50° C., the release agent melts in a developing device and causes aggregation of toner particles and the filming of the toner on a surface of a photoconductor. When the melting point is higher than 180° C., the release agent cannot melt sufficiently when the toner is fixed onto a recording medium, and the hot offset resistance is not improved sufficiently.

### (Magnetic Powder)

Examples of the magnetic powder to be included in the toner of the present invention include magnetite, γ-hematite and various ferrites.

### (Charge Controlling Agent)

As a charge controlling agent to be included in the toner of the present invention, charge controlling agents for positive charge control and negative charge control which are used regularly in the art can be used.

Examples of the charge controlling agents for positive charge control include nigrosine dyes, basic dyes, quaternary ammonium salts, quaternary phosphonium salts, aminopyrine, pyrimidinic compounds, polynuclear polyamino compounds, aminosilanes, nigrosine dyes and derivatives thereof, triphenylmethanes, guanidine salts, and amidine salts.

Examples of the charge controlling agent for negative charge control include surfactants such as chromium azo complex dyes, iron azo complex dyes, cobalt azo complex dyes, chromium complexes, zinc complexes, aluminum complexes and boron complexes of salicylic acid and salicylic acid derivatives, chromium complexes, zinc complexes, aluminum complexes and boron complexes of salicylate compounds, naphthol acid and naphthol acid derivatives, naphtholate compounds, benzilate compounds, long-chain alkyl carbonate, and long-chain alkyl sulfonate.

The addition amount of the charge controlling agent is preferably 0.01 to 5 parts by weight with respect to 100 parts by weight of the binder resin.

As the blender to be used in the mixing step S1, a commonly known blender can be used, and examples thereof include mixing equipment of a Henschel type such as Henschel mixer (trade name, available from Mitsui Mining Co., Ltd.), Super Mixer (trade name, available from KAWATA MFG Co., Ltd.), Mechanomill (trade name, available from OKADA SEIKO CO., LTD.); Angmill (trade name, available from Hosokawa Micron Corporation); Hybridization System (trade name, available from Nara Machinery Co., Ltd.); Cosmosystem (trade name, available from Kawasaki Heavy Industries, Ltd.); and the like.

### (2) Melting and Kneading Step S2

In the melting and kneading step S2, the mixture prepared in the mixing step is melted and kneaded with a kneading machine to give a melted and kneaded product including the binder resin in which a colorant, a benzilic acid compound and an additive added as needed are dispersed.

As the kneading machine to be used in the melting and kneading step, a commonly known kneading machine may be used, and the same kneading machine as the kneading machine used for the preparation of the masterbatch may be used. The melting and kneading may be performed by using a plurality of kneading machines.

Preferably, the temperature of the melting and kneading is 80 to 200° C., though it depends on the kneading machine to use. By performing the melting and kneading at a temperature in such a range, it is possible to uniformly disperse the colorant, the benzilic acid compound and the additive added as needed in the binder resin.

### (3) Cooling and Pulverizing Step S3

In the cooling and pulverizing step S3, the melted and kneaded product obtained in the melting and kneading step is cooled, solidified and pulverized to give a pulverized product.

The melted and kneaded product is cooled and solidified, and then coarsely pulverized into a coarsely pulverized product having a volumetric average particle diameter of 100 μm to 5 mm with a hammer mill or a cutting mill. The resulting coarsely pulverized product is further pulverized finely so as to have a volumetric average particle diameter of 15 μm or less, for example. For finely pulverizing the coarsely pulverized product, may be used a jet type pulverizer that uses a supersonic jet stream and an impact type pulverizer that introduces the coarsely pulverized product into a space formed between a rotator (rotor) that rotates at high speed and a stator (liner) to perform pulverization, for example.

### (4) Classifying Step S4

In the classifying step S4, the pulverized product obtained in the cooling and pulverizing step S3 is classified with a classifier so that overpulverized toner particles and coarse toner particles are removed to give toner having no external additive. The overpulverized toner particles and the coarse toner particles can be collected to be used in production of other toner.

For the classification, a commonly known classifier can be used which can remove overpulverized toner particles by classification using centrifugal force and pneumatic force, and examples thereof include a rotating type pneumatic classifier (rotary pneumatic classifier).

Preferably, the toner having no external additive obtained after the classification has a volumetric average particle diameter of 3 to 15 μm. In order to obtain high-quality images, the volumetric average particle diameter of the toner having no external additive is preferably 3 to 9 μm, and more preferably 5 to 8 μm.

When the volumetric average particle diameter of the toner having no external additive is less than 3 μm, the particle diameter of the toner is so small that the toner is highly charged and reduced in flowability. Being highly charged and reduced in flowability, furthermore, the toner cannot be steadily supplied to the photoconductor, and therefore background fogging, image density reduction, or the like is caused. When the volumetric average particle diameter of the toner having no external additive is more than 15 μm, the particle diameter of the toner is so large that it is not possible to obtain high-definition images. In addition, the large particle diameter results in a reduced specific surface area of the toner, and therefore the charge amount of the toner is reduced. As a result, the toner cannot be steadily supplied to the photoconductor, and therefore the inside of the apparatus is contaminated due to toner scattering.

### (5) Externally Adding Step S5

In the externally adding step S5, the toner having no external additive obtained in the classifying step S4 and an external additive are mixed to give a toner. The addition of the external additive can improve the flowability of the toner and the cleanability of the toner remaining on a photoconductor surface, and therefore the filming onto the photoconductor can be prevented. A toner to which no external additive is added can be used as the toner.

Examples of the external additive include inorganic oxides such as silica, alumina, titania, zirconia, tin oxide and zinc oxide; compounds such as acrylic acid esters, methacrylate esters and styrene, or copolymer resin microparticles, fluororesin microparticles, silicone resin microparticles of the compounds; high fatty acids such as stearic acid, or metal salts of the high fatty acids; carbon black; graphite fluoride; silicon carbide; and boron nitride.

Preferably, these external additives are surface-treated with a silicone resin, a silane coupling agent, or the like. Preferably, the addition amount of the external additive is 0.5 to 5 parts by weight with respect to 100 parts by weight of the binder resin.

Preferably, the primary particles of the external additive have a number average particle diameter of 10 to 500 nm. When the number average particle diameter of the primary particles of the external additive is within such a range, the flowability of the toner is further improved.

Preferably, the BET specific surface area of the external additive is 20 to 200 m²/g. When the BET specific surface area of the external additive is within such a range, it is possible to give appropriate flowability and chargeability to the toner.

### 2. Toner

The toner of the present invention is produced by the process for producing the toner according to the above-described embodiment. The toner obtained according to the above-described process for producing the toner has a sufficient mechanical strength, and excellent hot offset resistance and charging stability.

### 3. Developer

The toner according to the present invention may be used as a monocomponent developer consisting only of the toner or as a two-component developer in which the toner is mixed with a carrier.

As the carrier, a commonly known carrier can be used. Examples thereof include single or complex ferrite including iron, copper, zinc, nickel, cobalt, manganese and chromium; a resin coated carrier in which surfaces of carrier core particles are coated with a coating material; and a resin dispersion type carrier in which magnetic particles are dispersed in a resin.

As the coating material, a commonly known coating material can be used. Examples thereof include polytetrafluoroethylene, monochlorotrifluoroethylene polymer, polyvinylidene fluoride, silicone resins, polyester resins, di-tert-butylsalicylic acid metal compounds, styrene resins, acrylic resins, polyamide, polyvinylbutyral, nigrosine, aminoacrylate resins, basic dyes, lakes of basic dyes, fine silica powder and fine alumina powder.

The resin to be used for the resin dispersion type carrier is not particularly limited, and examples thereof include styrene acrylic resins, polyester resins, fluorinated resins and phenol resins. Preferably, these resins are selected according to the toner components. These resins may be used independently, or two or more kinds may be used in combination.

Preferably, the carrier has a spherical or flat shape. The particle diameter of the carrier is not particularly limited. For obtaining high-resolution images, however, the particle diameter of the carrier is preferably 10 to 100 μm, and more preferably 20 to 50 μm. When the particle diameter of the carrier is 50 μm or less, the toner and the carrier contact with each other more frequently, and therefore the charging of the respective toner particles can be appropriately controlled. As a result, fogging in an area having no image can be prevented, and high-resolution images can be formed.

Furthermore, the volume resistivity of the carrier is preferably 10⁸ Ω·cm or higher, and more preferably 10¹² Ω·cm or higher. The volume resistivity of the carrier is determined as follows. Carrier particles are placed in a container having a cross sectional area of 0.50 cm² and tapped, a load of 1 kg/cm² is applied to the particles placed in the container, and then a current value when a voltage to produce an electric field of 1000 V/cm is applied between the load and a bottom electrode is measured, from which the volume resistivity is obtained. In the case of a low resistivity, the carrier is charged when a bias voltage is applied to a developing sleeve, and the carrier particles will be likely to adhere to the photoconductor. In addition, the breakdown of the bias voltage will be likely to occur.

The magnetization (maximum magnetization) of the carrier is preferably 10 to 60 emu/g, and more preferably 15 to 40 emu/g. When the magnetization is less than 10 emu/g under a magnetic flux density condition of a general developing roller, magnetic restraining force does not work, causing carrier scattering. On the other hand, when the magnetization is more than 60 emu/g, bristles of the carrier are so high that it is difficult to keep the toner from contacting the image carrier in the case of non-contact development. In addition, in the case of contact development, brush lines are likely to be present in a toner image.

The ratio between the toner and the carrier to be used in the two-component developer is not particularly limited, and may be selected as appropriate according to the types of the toner and the carrier. Preferably, the coverage of the carrier with the toner is 40 to 80%.

### EXAMPLES

Hereinafter, the present invention will be described in detail with reference to examples and comparative examples.

The examples and the comparative examples were measured for physical properties as described below.

Glass Transition Temperature (Tg) of Polyester Resin

With the use of a differential scanning calorimetry (trade name: Diamond DSC, available from PerkinElmer Co., Ltd.), 0.01 g of a sample was heated at a rate of temperature rise of 10° C. per minute (10° C./minute) to measure a DSC curve according to Japanese Industrial Standard (JIS) K7121-1987. A temperature at an intersection point between a straight line obtained by extending a base line at a low-temperature side of the heat absorption peak corresponding to the glass transition in the obtained DSC curve toward a high-temperature side and a tangent line to a curve at the low-temperature side of the heat absorption peak drawn at a point allowing the gradient to be the maximum was determined as a glass transition temperature (Tg).

### Softening Temperature (Tm) of Polyester Resin

With the use of a flowability evaluation apparatus (trade name: FLOW TESTER CFT-500C, available from Shimazu Corporation), 1 g of a sample was heated at a rate of temperature rise of 6° C. per minute and given a load of 10 kgf/cm² (9.8×10⁵ Pa). A temperature when half the amount of the sample flowed out of a die (nozzle bore: 1 mm, length: 1 mm) was determined as a softening temperature (Tm).

Weight Average Molecular Weight (Mw) and Number Average Molecular Weight (Mn) of Polyester Resin

A sample was dissolved in tetrahydrofuran (THF) so as to be 0.25% by weight, and 200 μL of the sample was poured into a GPC instrument (trade name: HLC-8220GPC, available from Tosoh Corporation), whereby a molecular weight distribution curve was obtained at a temperature of 40° C.

A weight average molecular weight Mw and a number average molecular weight Mn were determined from the molecular weight distribution curve obtained, and the ratio of the weight average molecular weight Mw to the number average molecular weight Mn was determined as a molecular weight distribution index (Mw/Mn: hereinafter, also simply referred to as “Mw/Mn”). Here, a molecular weight calibration curve was prepared by using standard polystyrene.

### Acid Value of Polyester Resin and Rosin

The acid value was measured according to a neutralization titration method. In 50 mL of tetrahydrofuran (THF), 5 g of a sample was dissolved and several drops of an ethanol solution of phenolphthalein was added thereto as an indicator to carry out titration with 0.1 mol/L of a potassium hydroxide (KOH) aqueous solution. With a point when the color of the sample solution turned from colorless to violet as an end point, an acid value (mgKOH/g) was calculated from the amount of the potassium hydroxide aqueous solution needed until reaching the end point and the weight of the sample subjected to the titration.

### THF-Insoluble Fraction of Polyester Resin

A sample in an amount of 1 g was placed in a filter paper thimble and applied to a Soxhlet extractor. With the use of 100 mL of Tetrahydrofuran (THF) as an extracting solvent, heating under reflux was carried out for 6 hours, and a THF-soluble fraction was extracted from the sample. The solvent was removed from an extract containing the THF-soluble fraction, and then the THF-soluble fraction was dried at 100° C. for 24 hours. The resulting THF-soluble fraction was weighed to determine a weight X (g) thereof. A proportion P (% by weight) of a THF-insoluble fraction in the sample was calculated from the weight X (g) of the THF-soluble fraction and the weight of the sample used in the measurement (1 g) based on the following equation (1):

P(% by weight)={1(g)−X(g)}/1(g)×100 (1)

Hereinafter, this proportion P will be referred to as THF-insoluble fraction.

### Melting Point of Release Agent

With the use of a differential scanning calorimetry (trade name: Diamond DSC, available from PerkinElmer Japan Co., Ltd), 0.01 g of a sample was heated from 20° C. to 200° C. at a rate of temperature rise of 10° C. per minute, and then quenching from 200° C. to 20° C. was performed. This process was repeated twice to obtain DSC curves. A temperature of a heat absorption peak corresponding to melt in the DSC curve obtained when the process was performed for the second time was determined as the melting point of the release agent.

### Volumetric Average Particle Diameter and Coefficient of Variation of Toner

To 50 ml of an electrolytic solution (trade name: ISOTON-II, available from Beckman Coulter, Inc.), 20 mg of a sample and 1 ml of alkyl ether sulfuric acid ester sodium (dispersant, available from Kishida Chemical Co., Ltd.) were added and subjected to a dispersion treatment at a frequency of 20 kHz for 3 minutes with an ultrasonic disperser (trade name: UH-50, available from SMT Co., Ltd.) to give a measurement sample.

With the use of a particle size distribution measuring apparatus (trade name: Multisizer 3, available from Beckman Coulter, Inc.), the measurement sample was measured under conditions of an aperture diameter of 20 μm and a particle count of 50000 to obtain a volumetric particle size distribution of the sample particles, from which a volumetric average particle diameter was determined. In addition, a coefficient of variation of the toner was calculated based on the volumetric average particle diameter and the standard deviation thereof according to the following equation (2):

Coefficient of variation CV(%)=(standard deviation in volumetric particle size distribution/volumetric average particle diameter)×100 (2)

### Preparation Example 1

### Preparation of Polyester Resin A-1

A reaction vessel equipped with a stirring apparatus, a heating apparatus, a thermometer, a cooling tube, a fractionator and a nitrogen inlet was charged with 305 g of terephthalic acid, 55 g of isophthalic acid, 30 g of trimellitic anhydride and 1400 g of a disproportionated rosin (acid value: 157.2 mgKOH/g) as acid components; 300 g of glycerin and 150 g of 1,3-propanediol as alcohol components; and 1.79 g of tetra-n-butyl titanate as a catalyst (equivalent of 0.080 parts by weight with respect to 100 parts by weight of the total amount of the acid components and the alcohol components). These materials were stirred under a nitrogen atmosphere to carry out a polycondensation reaction at 250° C. for 10 hours while water generated was distilled off. The reaction was stopped when it was confirmed with a flow tester that a predetermined softening temperature was reached. Thus, 2015 g (yield: 90%) of a polyester resin A-1 (glass transition temperature: 60° C., softening temperature: 112° C., weight average molecular weight: 2800, Mw/Mn: 2.3, acid value: 24 mgKOH/g) was obtained.

### Preparation Example 2

### Preparation of Polyester Resin A-2

A polyester resin A-2 in an amount of 1980 g (yield: 88%) (glass transition temperature: 60° C., softening temperature: 115° C., weight average molecular weight: 4200, Mw/Mn: 2.9, acid value: 23 mgKOH/g) was obtained in the same manner as in Preparation Example 1 except that the reaction time was changed from 10 hours to 12 hours.

### Preparation Example 3

### Preparation of Polyester Resin B-1

A polyester resin B-1 in an amount of 2350 g (yield: 85%) (glass transition temperature: 63° C., softening temperature: 143° C., weight average molecular weight: 29500, Mw/Mn: 11.6, acid value: 22 mgKOH/g, THF-insoluble fraction: 22%) was obtained in the same manner as in the preparation of the polyester resin A-1 of Preparation Example 1 except that the materials and the amounts thereof were changed to those shown in Table 1.

### Preparation Example 4

### Preparation of Polyester Resin B-2

A polyester resin B-2 in an amount of 2450 g (yield: 84%) (glass transition temperature: 62° C., softening temperature: 136° C., weight average molecular weight: 48200, Mw/Mn: 12.3, acid value: 22 mgKOH/g, THF-insoluble fraction: 15%) was obtained in the same manner as in Preparation Example 1 except that the reaction time was changed from 10 hours to 12 hours.

### Preparation Example 5

### Preparation of Polyester Resin B-3

A polyester resin B-3 in an amount of 2500 g (yield: 91%) (glass transition temperature: 63° C., softening temperature: 160° C., weight average molecular weight: 1200000, Mw/Mn: 11.2, acid value: 17 mgKOH/g, THF-insoluble fraction: 23%) was obtained in the same manner as in Preparation Example 1 except that the reaction time was changed from 10 hours to 14 hours.

### Preparation Example 6

### Preparation of Polyester Resin B-4

A polyester resin B-4 in an amount of 2400 g (yield: 87%) (glass transition temperature: 62° C., softening temperature: 135° C., weight average molecular weight: 48200, Mw/Mn: 15.2, acid value: 23 mgKOH/g, THF-insoluble fraction: 29%) was obtained in the same manner as in Preparation Example 1 except that the materials and the amounts thereof were changed to those shown in Table 1.

### Preparation Example 7

### Preparation of Polyester Resin B-5

A polyester resin B-5 in an amount of 2500 g (yield: 89%) (glass transition temperature: 61° C., softening temperature: 121° C., weight average molecular weight: 13500, Mw/Mn: 8.9, acid value: 25 mgKOH/g, THF-insoluble fraction: 12%) was obtained in the same manner as in Preparation Example 1 except that the materials and the amounts thereof were changed to those shown in Table 1.

### Preparation Example 8

### Preparation of Polyester Resin B-6

A polyester resin B-6 in an amount of 2400 g (yield: 86%) (glass transition temperature: 64° C., softening temperature: 165° C., weight average molecular weight: 1400000, Mw/Mn: 12.5, acid value: 25 mgKOH/g, THF-insoluble fraction: 25%) was obtained in the same manner as in Preparation Example 1 except that the materials and the amounts thereof were changed to those shown in Table 1, and the reaction time was changed from 10 hours to 15 hours.

### Example 1

### <Mixing Step S1>

| | | |
|---|---|---|
| Polyester resin A-1 | 36.1 | parts by weight (3610 g) |
| Polyester resin B-1 | 54.2 | parts by weight (5416 g) |
| Colorant, KET. BLUE111 | 5.5 | parts by weight (550 g) |
| (trade name: copper | | |
| phthalocyanine 15:3, | | |
| available from Clariant | | |
| Japan K.K.) | | |
| Release agent, paraffin | 3.3 | parts by weight (330 g) |
| wax (trade name: HNP-10, | | |
| available from Nippon | | |
| Seiro Co., Ltd., melting | | |
| point (Tm): 75° C.) | | |
| Charge controlling agent | 1.7 | parts by weight (170 g) |
| (trade name: Copy Charge | | |
| N4P VP2481, available | | |
| from Clariant Japan K.K.) | | |

These materials were mixed by using a Henschel mixer (trade name: FM20C, available from Mitsui Mining Co., Ltd.) for 3 minutes to give 10 kg of a mixture.

### <Melting and Kneading Step S2>

The mixture obtained in the mixing step S1 was melted and kneaded by using a kneading machine (trade name: twin-screw kneader PCM-60, available from Ikegai Corporation) at a cylinder temperature set to 80° C. to 120° C. (maximum temperature: 120° C.), at a rotation frequency of 250 rpm, and at a rate of feed of 5 kg/h to give a melted and kneaded product.

### <Cooling and Pulverizing Step S3>

The melted and kneaded product obtained in the melting and kneading step S2 was cooled to room temperature, solidified, and then coarsely pulverized by using a cutter mill (trade name: VM-16, available from ORIENT Co, Ltd.) Subsequently, the resulting coarsely pulverized product was finely pulverized by using a counter jet mill (trade name: AFG, available from Hosokawa Micron Corporation).

### <Classifying Step S4>

The pulverized product obtained in the cooling and pulverizing step S3 was classified by using a rotary classifier (trade name: TSP separator, available from Hosokawa Micron Corporation) to give a toner having no external additive.

### <Externally Adding Step S5>

To 100 parts by weight (500 g) of the toner having no external additive obtained in the classifying step S4, 1.2 parts by weight (6 g) of hydrophobic fine silica powder A (BET specific surface area: 140 m²/g) surface-treated with a silane coupling agent and dimethyl silicone oil, 0.8 parts by weight (4 g) of hydrophobic fine silica powder B (BET specific surface area: 30 m²/g) surface-treated with a silane coupling agent, and 0.5 parts by weight (2.5 g) of titanium oxide (BET specific surface area: 130 m²/g) were added and mixed by using a Henschel mixer (trade name: FM mixer, available from Mitsui Mining Co., Ltd.) to give a toner of Example 1 (volumetric average particle diameter: 6.7 μm, CV value: 25%).

### Example 2

A toner of Example 2 (volume average particle diameter: 6.7 μm, CV value: 24%) was obtained in the same manner as in Example 1 except that the addition amount of the polyester resin B-1 was changed to the amount shown in Table 2 below in the mixing step S1.

### Example 3

A toner of Example 3 (volume average particle diameter: 6.7 μm, CV value: 24%) was obtained in the same manner as in Example 1 except that the addition amount of the polyester resin B-1 was changed to the amount shown in Table 2 below in the mixing step S1.

### Example 4

A toner of Example 4 (volume average particle diameter: 6.7 μm, CV value: 25%) was obtained in the same manner as in Example 1 except that the polyester resin A-2 obtained in Preparation Example 4 was used instead of the polyester resin A-1 in the mixing step S1.

### Example 5

A toner of Example 5 (volume average particle diameter: 6.7 μm, CV value: 24%) was obtained in the same manner as in Example 1 except that the polyester resin B-2 obtained in Preparation Example 4 was used instead of the polyester resin B-1 in the mixing step S1.

### Example 6

A toner of Example 6 (volume average particle diameter: 6.7 μm, CV value: 24%) was obtained in the same manner as in Example 1 except that the polyester resin B-3 obtained in Preparation Example 5 was used instead of the polyester resin B-1 in the mixing step S1.

### Comparative Example 1

A toner of Comparative Example 1 (volume average particle diameter: 6.7 μm, CV value: 24%) was obtained in the same manner as in Example 1 except that the addition amount of the polyester resin B-1 was changed to the amount shown in Table 2 below in the mixing step S1.

### Comparative Example 2

A toner of Comparative Example 2 (volume average particle diameter: 6.7 μm, CV value: 24%) was obtained in the same manner as in Example 1 except that the addition amount of the polyester resin B-1 was changed to the amount shown in Table 2 below in the mixing step S1.

### Comparative Example 3

A toner of Comparative Example 3 (volume average particle diameter: 6.7 μm, CV value: 24%) was obtained in the same manner as in Example 1 except that the polyester resin B-4 obtained in Preparation Example 6 was used instead of the polyester resin B-1 in the mixing step S1.

### Comparative Example 4

A toner of Comparative Example 4 (volume average particle diameter: 6.7 μm, CV value: 24%) was obtained in the same manner as in Example 1 except that the polyester resin B-5 obtained in Preparation Example 7 was used instead of the polyester resin B-1 in the mixing step S1.

### Comparative Example 5

A toner of Comparative Example 5 (volume average particle diameter: 6.7 μm, CV value: 24%) was obtained in the same manner as in Example 1 except that the polyester resin B-6 obtained in Preparation Example 8 was used instead of the polyester resin B-1 in the mixing step S1.

TABLE 1

| | Polyester resin | | | | | | | |
|---|---|---|---|---|---|---|---|---|
| | A-1 | A-2 | B-1 | B-2 | B-3 | B-4 | B-5 | B-6 |
| Terephthalic acid | 305 | 305 | 350 | 350 | 350 | 750 | 350 | 350 |
| Isophthalic acid | 55 | 55 | 230 | 230 | 230 | 1200 | 230 | 230 |
| Disproportionated rosin | 1400 | 1400 | 1200 | 1200 | 1200 | 0 | 1200 | 1200 |
| Trimellitic anhydride | 30 | 30 | 50 | 50 | 75 | 50 | 50 | 75 |
| Glycerin | 300 | 300 | 125 | 125 | 150 | 125 | 125 | 150 |
| 1,3-propanediol, | 150 | 150 | 0 | 0 | 0 | 0 | 0 | 0 |
| Bispenol A (PO 2 moles adduct) | 0 | 0 | 350 | 350 | 350 | 350 | 350 | 350 |
| Bispenol A (PO 3 moles adduct) | 0 | 0 | 450 | 450 | 450 | 450 | 450 | 450 |
| Total amount (g) | 2240 | 2240 | 2755 | 2755 | 2805 | 2925 | 2755 | 2805 |
| Glass transition temperature (° C.) | 60 | 60 | 63 | 62 | 63 | 62 | 61 | 64 |
| Softening temperature (° C.) | 112 | 115 | 143 | 136 | 160 | 135 | 121 | 165 |
| Weight average molecular weight (Mw) | 2.80 × 10³ | 4.20 × 10³ | 2.95 × 10⁴ | 4.82 × 10⁴ | 1.20 × 10⁵ | 4.82 × 10⁴ | 1.35 × 10⁴ | 1.40 × 10⁵ |
| Mw/Mn | 2.3 | 2.9 | 11.6 | 12.3 | 11.2 | 15.2 | 8.9 | 12.5 |
| Acid value (mgKOH/g) | 24 | 23 | 22 | 22 | 17 | 23 | 25 | 17 |
| THF-insoluble fraction (gel fraction) (%) | 0 | 0 | 22 | 15 | 23 | 29 | 12 | 25 |
| Polyester resin B G″ (Pa · s) | — | — | 8.5 × 10³ | 1.2 × 10³ | 9.5 × 10⁴ | 9.3 × 10³ | 9.5 × 10² | 1.2 × 10⁵ |
| Yield (g) | 2015 | 1980 | 2350 | 2450 | 2500 | 2400 | 2500 | 2400 |

The following evaluations were performed using the toners of Examples 1 to 6 and Comparative Examples 1 to 5.

### [Hot Offset Resistance]

A ferrite core carrier having a volumetric average particle diameter of 45 μm as a carrier and each toner of Examples 1 to 6 and Comparative Examples 1 to 5 were mixed by using a V type mixer (trade name: V-5, available from TOKUJU Co., LTD.) for 20 minutes so that the coverage of the toner on the carrier would be 60% to give a two-component developer.

A machine obtained by modifying a color multifunction printer (trade name: MX-2700, available from Sharp Corporation) was charged with the two-component developer obtained, and an unfixed image of a sample image including a 20-by-50 mm rectangle-shaped solid image part was formed on a recording paper (trade name: PPC paper SF-4AM3, available from Sharp Corporation) as a recording medium, while the adhesion amount of the toner in an unfixed state to the recording paper in the solid image part was adjusted so as to be 0.5 mg/cm². The unfixed image formed was evaluated for a non-offset region by using an external fixing device produced using a fixing unit of the color multifunction printer. The fixing process was performed at a rate of 124 mm/second and at a fixing roller temperature raised from 130° C. in increments of 5° C. Presence or absence of offset on a surface of the paper was confirmed by visual observation to determine the non-offset region, which is a temperature region where no cold offset and no hot offset was observed. Then, the hot offset resistance was evaluated according to the following criteria.

Here, the hot offset and the cold offset are defined as follows: The toner is not fixed onto the recording paper at the time of fixing, being left on the fixing roller, and adheres to the recording paper after another rotation of the roller.

The criteria of the evaluation of the hot offset resistance are shown below.

“G”: good: The hot offset start temperature is not below 230° C.
“NB”: not bad: The hot offset start temperature is not below 180° C. and below 230° C.
“B”: bad: The hot offset start temperature is below 180° C.

### [Transparency]

Each two-component developer was prepared in the same manner as in the evaluation of the hot offset resistance. By using a machine obtained by modifying a color multifunction printer (trade name: MX-2700, available from Sharp Corporation), a fixed image of a sample image was formed, while the adhesion amount of the toner onto an OHP sheet was adjusted so as to be 1.7 mg/cm². The HAZE value of the resulting fixed image was measured using a HAZE meter, model NDH2000 (trade name, available from Nippon Denshoku Industries Co., Ltd.), and the optical transparency was evaluated. A smaller HAZE value means a better optical transparency.

The criteria of the evaluation of the transparency are shown below.

“G”: good: The HAZE value is less than 20.
“NB”: not bad; The HAZE value is not less than 20 and less than 25.
“B”: bad: The HAZE value is not less than 25.

### [Mechanical Strength]

A color multifunction printer (trade name: MX-2700, available from Sharp Corporation) was charged with a two-component developer containing each toner and operated with a recording paper (trade name: PPC paper SF-4AM3, available from Sharp Corporation) as a recording medium in an environment at 25° C. and 45% RH. The volume average particle diameter (D₅₀) of the toner in the two-component developer was measured after 20000 sheets of printing, and the ratio thereof to an initial D₅₀ (volume average particle diameter of the toner before the operation) was calculated as a particle diameter rate based on the following equation (4):

Particle diameter rate(%)=D₅₀/(initial D₅₀)×100 (4)

The mechanical strength was evaluated according to the following criteria. When the toner is weak, the toner is crushed by stress such as stirring in the developer tank, and the particle size is decreased. Accordingly, a toner having a higher particle diameter rate has better mechanical strength.
“G”: good: The particle diameter rate is not less than 90%.
“NB”: not bad: The particle diameter rate is not less than 80% and less than 90%.
“B”: bad: The particle diameter rate is less than 80%.

### [Charging Stability]

The color multifunction printer was operated in the same manner as in the evaluation of the mechanical strength, and a document having an image area of 5% was printed on 20000 sheets of paper. Subsequently, the charge amount rate of the toner in the two-component developer, the image density and the fogging density were measured.

### [Charge Amount Rate]

A charge amount measuring apparatus (trade name: 210HS-2A, available from Treck Japan KK) was used for the measurement. Each two-component developer was placed in a metallic container having a 500-mesh conductive screen at a bottom thereof, and only the toner was suctioned by a suction device at a suction force of 250 mmHg. The charge amount of the toner was determined from a difference between the weight of the two-component developer before the suction and the weight of the two-component developer after the suction, and a potential difference between capacitor plates connected to the container. The ratio of the charge amount thus obtained to the initial charge amount of the toner (charge amount of the toner before the operation) was calculated as the charge amount rate based on the following equation (5):

Charge amount rate %=[charge amount of toner(μC/g)/initial charge amount of toner(μC/g)]×100 (5)

The charge amount rate was evaluated according to the following criteria.

The criteria of the evaluation of the charge amount rate are as follows.

“G”: good: The charge amount rate is not less than 80%.
“NB”: not bad: The charge amount rate is not less than 70% and less than 80%.
“B”: bad: The charge amount rate is less than 70%.

### [Image Density]

A solid image, 3 cm on a side, having a density of 100% was printed, and the image density of the printed area was measured by using a reflection densitometer (trade name: RD918, available from MacBeth) to be evaluated according to the following criteria.

“G”: good: The image density is not less than 1.4.
“NB”: not bad: The image density is not less than 1.2 and less than 1.4.
“B”: bad: The image density is less than 1.2.

### [Fogging Density]

With the use of a whiteness colorimeter (trade name: Z-E90 COLOR MEASURING SYSTEM, available from Nippon Denshoku Industries Co., Ltd.), the whiteness degree of a non-image area (density: 0%) was measured. The difference between the whiteness degree measured and the whiteness degree preliminarily measured before the printing was determined as a fogging density to be evaluated according to the following criteria.

“G”: good: The fogging density less than 0.5.
“NB”: not bad: The fogging density is not less than 0.5 and less than 1.0.
“B”: bad: The fogging density is not less than 1.0.

### [Overall Evaluation]

With the use of the evaluation results of the hot offset resistance, the transparency, the mechanical strength, the charging stability, the charge amount rate, the image density and the fogging density, overall evaluation was made according to the following overall evaluation criteria.

“G”: good: Good; No problem for practical use; the evaluation results are “G” or “NB”.
“B”: bad: Bad; the evaluation results include “B”.

TABLE 2

| | Polyester resin | | | | | | | | |
|---|---|---|---|---|---|---|---|---|---|
| | | | | | Amount | | | | |
| | | | | | of | | | | |
| | | | | | polyester | | | | |
| | | | | | resin B | | | | |
| | | | | | added | | | | |
| | | | | | relative to | Hot offset | | | |
| | | | | | 100 parts by | resistance | | | |
| | | | G″ | Softening | weight of | Hot | | | |
| | | | (viscosity | point of | polyester | offset | | | |
| | | Rosin in | Pa · s) of | polyester | resin A | start | | Transparency | |
| | Polyester | polyester | polyester | resin B | (parts by | temp. | | HAZE | |
| | resin A | resin B | resin B | (° C.) | weight) | (° C.) | Evaluation | value | Evaluation |
| Example 1 | A-1 | Present | B-1 | 143 | 150 | 250 | G | 18 | G |
| | | | (8.5 × 10³) | | | | | | |
| Example 2 | A-1 | Present | B-1 | 143 | 55 | 190 | NB | 18 | G |
| | | | (8.5 × 10³) | | | | | | |
| Example 3 | A-1 | Present | B-1 | 143 | 195 | 250 | G | 20 | NB |
| | | | (8.5 × 10³) | | | | | | |
| Example 4 | A-2 | Present | B-1 | 143 | 150 | 250 | G | 18 | G |
| | | | (8.5 × 10³) | | | | | | |
| Example 5 | A-1 | Present | B-2 | 136 | 150 | 220 | NB | 18 | G |
| | | | (1.2 × 10³) | | | | | | |
| Example 6 | A-1 | Present | B-3 | 160 | 150 | 250 | G | 20 | NB |
| | | | (9.5 × 10⁴) | | | | | | |
| Comparative | A-1 | Present | B-1 | 143 | 45 | 175 | B | 18 | G |
| Example 1 | | | (8.5 × 10³) | | | | | | |
| Comparative | A-1 | Present | B-1 | 143 | 205 | 250 | G | 25 | B |
| Example 2 | | | (8.5 × 10³) | | | | | | |
| Comparative | A-1 | Absent | B-4 | 147 | 150 | 250 | G | 25 | B |
| Example 3 | | | (9.3 × 10³) | | | | | | |
| Comparative | A-1 | Present | B-5 | 121 | 150 | 175 | B | 18 | G |
| Example 4 | | | (9.5 × 10²) | | | | | | |
| Comparative | A-1 | Present | B-6 | 165 | 150 | 220 | NB | 25 | B |
| Example 5 | | | (1.2 × 10⁵) | | | | | | |

| | Mechanical | | | | | | | | |
|---|---|---|---|---|---|---|---|---|---|
| | strength | | Charging stability | | | | | | |
| | Particle | | Charge | | | | | | |
| | diameter | | amount | | Image evaluation | | | | |
| | rate | | rate | | Image | | Fogging | | Overall |
| | (%) | Evaluation | (%) | Evaluation | density | Evaluation | density | Evaluation | evaluation |
| Example 1 | 90 | G | 83 | G | 1.5 | G | 0.4 | G | G |
| Example 2 | 83 | NB | 78 | NB | 1.5 | G | 0.7 | NB | G |
| Example 3 | 93 | G | 85 | G | 1.3 | NB | 0.4 | G | G |
| Example 4 | 91 | G | 83 | G | 1.4 | G | 0.4 | G | G |
| Example 5 | 85 | NB | 79 | NB | 1.5 | G | 0.7 | NB | G |
| Example 6 | 93 | G | 84 | G | 1.4 | G | 0.7 | NB | G |
| Comparative | 75 | B | 72 | NB | 1.6 | G | 0.7 | NB | B |
| Example 1 | | | | | | | | | |
| Comparative | 94 | G | 85 | G | 1.3 | NB | 0.6 | NB | B |
| Example 2 | | | | | | | | | |
| Comparative | 88 | NB | 81 | G | 1.4 | G | 0.5 | NB | B |
| Example 3 | | | | | | | | | |
| Comparative | 70 | B | 67 | B | 1.6 | G | 0.8 | NB | B |
| Example 4 | | | | | | | | | |
| Comparative | 83 | NB | 79 | NB | 1.5 | G | 0.8 | NB | B |
| Example 5 | | | | | | | | | |

The table shows that the toners prepared in Examples 1 to 6 according to the present invention were evaluated as “good” or “not bad” in all the evaluations of the hot offset resistance, the transparency, the mechanical strength, the charging stability, the image density and the fogging density, and evaluated as “good” also in the overall evaluation.

### INDUSTRIAL APPLICABILITY

The present invention provides: a toner containing a high amount of rosin derived from biomass and having excellent hot offset resistance, charging stability and optical transparency; and a process for producing the same.

1. A toner comprising at least a binder resin, a colorant and a release agent, wherein the binder resin contains: a polyester resin A obtained by polycondensation of an aromatic dicarboxylic acid, a rosin and an alcohol having three or more hydroxyl groups, a content of the rosin being 60% by weight or more; and a polyester resin B obtained by polycondensation of an aromatic dicarboxylic acid, a rosin and a polyhydric alcohol, a content of the rosin being 5 to 60% by weight, wherein 50 to 200 parts by weight of the polyester resin B is contained with respect to 100 parts by weight of the polyester resin A.

2. The toner according to claim 1, wherein the rosins are disproportionated rosins.

3. The toner according to claim 1, wherein the polyester resin A has a softening temperature of 120° C. or lower.

4. The toner according to claim 1, wherein the polyester resin A has a weight average molecular weight of 1.00×10³ to 9.00×10³.

5. The toner according to claim 1, wherein the polyester resin A is soluble in tetrahydrofuran.

6. The toner according to claim 1, wherein the polyester resin B has a storage modulus of 10³ to 10⁵ Pa·s at the softening temperature of the polyester resin A.

7. The toner according to claim 1, wherein the polyester resin B has a softening temperature of 160° C. or lower.

8. A process for producing a toner comprising at least a binder resin, a colorant and a release agent, the process comprising: a mixing step of mixing a binder resin with a colorant to prepare a mixture; a melting and kneading step of melting and kneading the mixture to prepare a kneaded product; a cooling and pulverizing step of cooling, solidifying and pulverizing the kneaded product to prepare a pulverized product; and a classifying step of classifying the pulverized product, wherein the binder resin contains: a polyester resin A obtained by polycondensation of an aromatic dicarboxylic acid, a rosin and an alcohol having three or more hydroxyl groups, a content of the rosin being 60% by weight or more; and a polyester resin B obtained by polycondensation of an aromatic dicarboxylic acid, a rosin and a polyhydric alcohol, a content of the rosin being 5 to 60% by weight, wherein 50 to 200 parts by weight of the polyester resin B is contained with respect to 100 parts by weight of the polyester resin A.

9. The process for producing the toner according to claim 8, wherein the mixing step comprises mixing and kneading the polyester resin A with the colorant to prepare a masterbatch, and mixing the polyester resin B with the masterbatch to prepare a mixture.
